(19) United States
(12) Patent Application Publication
(10) Pub. No.: US 2026/0311576 A1
(43) Pub. Date: Oct. 8, 2026

(54) FREIGHT SECURITY DEVICE

(71) Applicant: Michael F. Kitzman, Lookout Mountain, TN (US)

(72) Inventor: Michael F. Kitzman, Lookout Mountain, TN (US)

(21) Appl. No.: 19/635,359

(22) Filed: Mar. 31, 2026

Related U.S. Application Data
(60) Provisional application No. 63/782,098, filed on Apr. 2, 2025.

(51) Int. Cl. G08B 13/06; G01P 15/08; G01S 19/16; G06Q 10/0833

(52) U.S. Cl. CPC G08B 13/06; G01P 15/08; G01S 19/16; G06Q 10/0833

(57) ABSTRACT

A freight security device includes a first strap comprising a first strap body and a first wire embedded within the first strap body; a second strap comprising a second strap body and a second wire embedded within the second strap body, the second strap further comprising a head, the head comprising a securing tooth; and a housing disposed between the first strap and the second strap, the housing comprising a circuit board, each of the first wire and the second wire connected to the circuit board; wherein the first strap is configured to be fed through the head of the second strap, and close a circuit of the freight security device.

### REFERENCE TO RELATED APPLICATIONS

This application claims the benefit of U.S. Provisional Application No. 63/782,098, filed Apr. 2, 2025, which is hereby specifically incorporated by reference herein in its entirety.

### TECHNICAL FIELD

This disclosure relates to security devices. More specifically, this disclosure relates to a freight security device comprising location tracking and tamper detection features.

### BACKGROUND

Freight containers are commonly used for the transportation and delivery of goods. Some freight containers are provided with a location tracking device, allowing a customer to track the location of the container during transport. Freight containers often comprise a door or doors that can be closed, and usually locked, during transit of the container. However, customers may have no way of knowing whether the doors were opened and/or the goods were exposed or tampered with during transit.

### SUMMARY

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Disclosed is a freight security device comprising a first strap comprising a first strap body and a first wire embedded within the first strap body; a second strap comprising a second strap body and a second wire embedded within the second strap body, the second strap further comprising a head, the head comprising a securing tooth; and a housing disposed between the first strap and the second strap, the housing comprising a circuit board, each of the first wire and the second wire connected to the circuit board; wherein the first strap is configured to be fed through the head of the second strap, and wherein the securing tooth is configured to secure the first strap to the second strap and to close a circuit of the freight security device.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a top perspective view of the freight security device, in accordance with one aspect of the present disclosure.

FIG. 2 is a bottom perspective view of the freight security device of FIG. 1.

FIG. 3 is a top perspective view of a housing of the freight security device of FIG. 1.

FIG. 4 is a cross-sectional view of the housing of FIG. 3, taken along line C-C in FIG. 1.

FIG. 5 is a top perspective view of a first strap of the freight security device of FIG. 1.

FIG. 6 is a cross-sectional view of the first strap of FIG. 5, taken along line C-C in FIG. 1.

FIG. 7 is a top perspective view of a second strap of the freight security device of FIG. 1.

FIG. 8 is a cross-sectional view of the second strap of FIG. 7, taken along line C-C in FIG. 1.

FIG. 9 is a bottom perspective view of a head of the second strap of FIG. 7.

FIG. 10 is a cross-sectional view of the head of FIG. 9, taken along line C-C in FIG. 1.

FIG. 11 is a cross-sectional view of the freight security device of FIG. 1, taken along line C-C in FIG. 1.

FIG. 12 is a bottom view of the freight security device of FIG. 1, wherein the housing is arranged in a closed position.

FIG. 13 is a top perspective view of various circuit components of the freight security device, in accordance with an example aspect of the present disclosure.

FIG. 14 is a top perspective view of the housing of the freight security device, in accordance with an example aspect of the present disclosure.

FIGS. 15, 16, and 17 are top perspective, bottom perspective, and front views, respectively, of the freight security device, in accordance with another example aspect of the present disclosure.

FIGS. 18 and 19 are front and top perspective views, respectively, showing various circuit components and internal components of the freight security device of FIGS. 15-17, in accordance with another example aspect of the present disclosure.

FIGS. 20 and 21 illustrate top and front views, respectively, of the freight security device, in accordance with another example aspect of the present disclosure.

FIGS. 22 and 23 front and top views, respectively, showing various circuit components and internal components of the freight security device of FIGS. 20 and 21, in accordance with another example aspect of the present disclosure.

FIG. 24 illustrates the freight security device according to another example aspect of the present disclosure.

FIG. 25 illustrates the freight security device according to another example aspect of the present disclosure.

FIG. 26 illustrates the freight security device according to another example aspect of the present disclosure.

FIG. 27 illustrates the freight security device according to another example aspect of the present disclosure.

FIG. 28 illustrates a cross sectional view of the housing of the freight security device according to another example aspect of the present disclosure.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutations of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed is a freight security device and associated methods, systems, devices, and various apparatus. Example aspects of the freight security device can comprise a first strap, a second strap, and a housing. The freight security device can form a closed circuit when oriented in a looped configuration. It would be understood by one of skill in the art that the freight security device is described in but a few exemplary embodiments among many. No particular terminology or description should be considered limiting on the disclosure or the scope of any claims issuing therefrom.

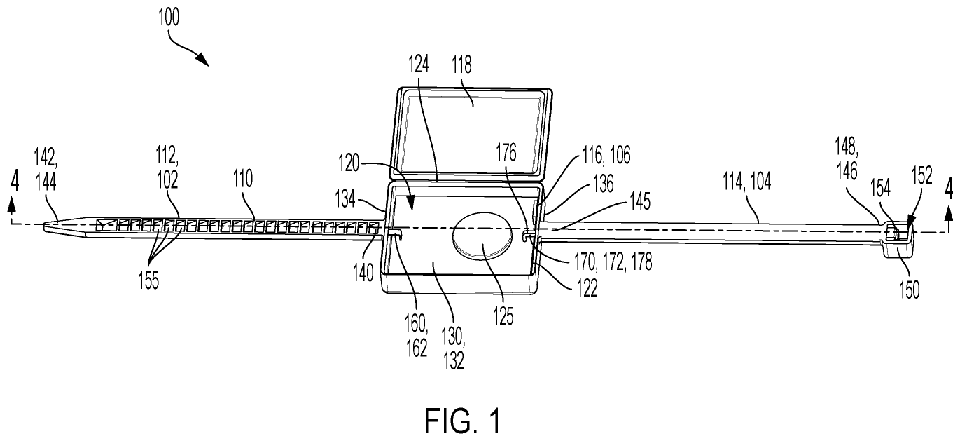

FIGS. 1-11 illustrate various views of a freight security device 100, in accordance with an example aspect of the present disclosure. The freight security device 100 can be attached to a freight container (or other similar payload), and can provide one or both of location tracking and tamper detection for the freight container during transportation. For example, the freight container may be transported by plane, ship, railroad, semi-truck, or any other suitable transportation vehicle. In some aspects, the freight security device 100 can share some similarities in structure to a standard zip tie fastener, as will be made clear in the following description.

Referring to FIG. 1, according to example aspects, the freight security device 100 can comprise a first strap 102, a second strap 104, and a housing 106 arranged between the first strap 102 and the second strap 104. The first strap 102 can comprise a first strap body 112 and the second strap 104 can comprise a second strap body 114. In some aspects, the first strap body 112, the second strap body 114, and the housing 106 of the freight security device 100 can be molded monolithically as a singular component that constitutes a single material without joints or seams. The first strap body 112, the second strap body 114, and the housing 106 can together define a security device body 110 of the freight security device 100. The security device body 110 can comprise a molded plastic material in some aspects. The security device body 110 can comprise an electrically conductive plastic material in some aspects. The molded plastic material can be substantially hard, but bendable. In other aspects, the security device body 110 can comprise any other suitable material(s) that is suitably hard and bendable.

Example aspects of the housing 106 can comprise a housing body 116 and a housing cover 118. The housing cover 118 can be monolithically molded with the housing body 116. The housing cover 118 can be molded in an open position relative to the housing body 116, such that access is permitted to an interior 120 of the housing body 116. The interior 120 can be accessed through a housing opening 122 of the housing body 116. Various internal components can be arranged within the housing body 116, and the housing cover 118 can then be sealed in a closed position to protect and retain the internal components within the housing body 116.

For example, in a particular aspect, the housing cover 118 and/or the housing body 116 can be heated to melt the plastic material, and the housing cover 118 can be folded towards the housing body 116 at a housing hinge 124 to cover the housing opening 122 in the closed position. The melted plastic of the housing cover 118 or housing body 116 can contact and solidify with the other one of the housing cover 118 or housing body 116 to form a water-tight seal therebetween. The internal components within the housing 106 can thereby be protected from moisture, dirt, and any other undesirable external elements. The internal components can comprise, but are not limited to, a battery 125, a circuit board 130, a GPS receiver, an accelerometer, and/or a gyroscope, as described in further detail below, and any other suitable components as desired by the manufacturer. The circuit board 130 (such as a printed circuit board 132, i.e., a PCB, for example) and the battery 125 are shown in FIG. 1. The battery 125 can be mounted to the circuit board 130 and can be configured to supply energy thereto. In other aspects, the housing cover 118 can be secured in the closed position via any other suitable fastener or fastening technique, including but not limited to gluing, ultrasonic welding, etc.

The housing 106 can define a first housing side 134 and a second housing side 136 opposite the first housing side 134. The first strap 102 can extend in a first direction from the first housing side 134. The first strap 102 can define a proximal first strap end 140 connected to the housing 106 and a distal first strap end 142 distal to the housing 106. The distal first strap end 142 of the first strap 102 can be a free end, and can be referred to as an insertion end 144 of the freight security device 100. The second strap 104 can extend in a second direction, opposite the first direction, from the second housing side 136. The second strap 104 can define a proximal second strap end 145 connected to the housing 106 and a distal second strap end 146 distal to the housing 106. The distal second strap end 146 of the second strap 104 can be a free end, and can be referred to as a receiving end 148 of the freight security device 100.

Example aspects of the second strap body 114 can comprise a head 150 formed at the receiving end 148. The head 150 can define a slot 152 that can be configured to receive the insertion end 144 of the first strap 102 in a looped configured, as described in further detail below. The head 150 can further comprise a securing tooth 154 arranged within the slot 152 and configured to puncture and grip the first strap 102 to secure the freight security device 100 in the looped configuration. Example aspects of the securing tooth 154 can comprise a suitably conductive metal material. For example, the securing tooth 154 can comprise steel in some aspects. Other aspects of the securing tooth 154 can comprise any other suitably conductive material(s), such as, for example, silver, copper, gold, aluminum, electrically conductive plastic, etc. The securing tooth 154 can therefore be formed separately from the security device body 110 in some aspects. Other aspects may comprise two or more of the securing teeth 154.

Some example aspects of the first strap body 112 can comprise one or more ratchet teeth 155 arranged in series at least partially along a length of the first strap 102, between the proximal first strap end 140 and the distal first strap end 142. In the present aspect, the ratchet teeth 155 can be formed substantially along the length of the first strap 102. The ratchet teeth 155 can be formed monolithically with the security device body 110.

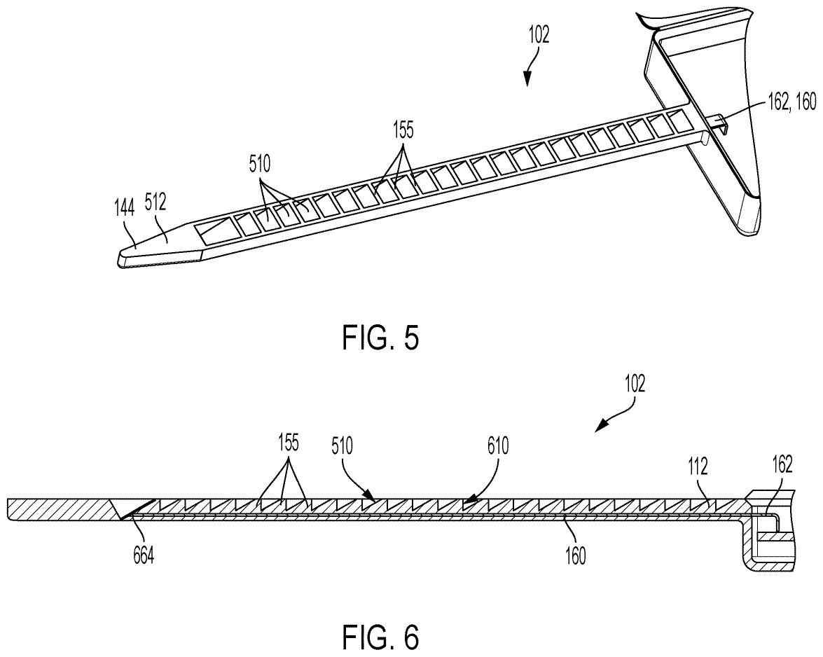

As the first strap 102 is fed through the slot 152 of the second strap 104, the securing tooth 154 can ratchet past one or more of the ratchet teeth 155 to a desired position along the second strap 104. Each of the ratchet teeth 155 can define a canted tooth surface 510 (best seen in FIGS. 5 and 6) facing towards the insertion end 144 of the first strap 102. The canted tooth surface 510 of each ratchet tooth 155 can allow the securing tooth 154 to easily slide over the ratchet teeth 155 as the first strap 102 is fed through the slot 152 (i.e., in a tightening direction). Each of the ratchet teeth 155 can further define a perpendicular tooth surface 610 (best seen in FIG. 6) facing towards the proximal first strap end 140 of the first strap 102. The securing tooth 154 can catch on the perpendicular tooth surface 610 of an adjacent ratchet tooth 155, which can prohibit the first strap 102 from sliding backwards through the slot 152 (i.e., in a loosening direction), thereby securing the freight security device 100 in the looped configuration. In the looped configuration, the freight security device 100 can define a secure, continuous loop.

According to example aspects, a first wire 160 can be embedded within the first strap body 112 of the first strap 102, and a second wire 170 can be embedded within the second strap body 114 of the second strap 104. Each of the first wire 160 and the second wire 170 can comprise a copper material in the present aspect. However, in other aspects, the first wire 160 and/or the second wire 170 can comprise any other suitably conductive material. The first wire 160 can extend substantially along the length of the first strap 102. In some aspects, the first wire 160 can extend partially along the length of the first strap 102. A proximal first wire end 162 of the first wire 160 can further extend beyond the proximal first strap end 140 of the first strap 102 and into the interior 120 of the housing 106. The proximal first wire end 162 can be connected to the circuit board 130 within the interior 120 of the housing 106, as shown. A distal first wire end 664 (shown in FIG. 6) of the first wire 160 can terminate within the first strap body 112, proximate the insertion end 144. In example aspects, the plastic material of the security device body 100 can be molded over the first wire 160, the second wire 170, and an attachment portion of the securing tooth 124.

In some example aspects, the first wire 160 can be a substantially flat wire. In some example aspects, a width of the first wire 160 can be nearly or about equal to half of a width of the first strap body 112. In some example aspects, the width of the first wire 160 can be about equal to a width of the securing tooth 154. In other aspects, the width of the first wire 160 can be greater or lesser than the width of the first strap body 112 and/or can be greater or lesser than the width of the securing tooth 154. In other aspects, the first wire 160 may not be substantially flat.

Similarly, the second wire 170 can extend substantially along the length of the second strap 104. In some aspects, the second wire 170 can extend partially along the length of the second strap 104. In the present aspect, the second wire 170 can comprise both a positive wire 176 and a negative wire 178. In some aspects, the positive wire 176 and the negative wire 178 may be color coded. For example and without limitation, in a particular aspect, the positive wire 176 can comprise a red sheath and the negative wire 178 can comprise a black sheath. A proximal second wire end 172 of the second wire 170 (that is, a proximal second wire end 172 of each of the positive wire 176 and the negative wire 178) can further extend beyond the proximal second strap end 145 of the second strap 104 and into the interior 120 of the housing 106. The proximal second wire end 172 can be connected to the circuit board 130 within the interior 120 of the housing 106, as shown. A distal second wire end 874 (shown in FIG. 8) (that is, a distal second wire end 874 of each of the positive wire 176 and the negative wire 178), opposite the proximal second wire end 172, can contact the securing tooth 154 at the head 150 of the second strap 104. In some aspects, the second wire 170 (that is, each of the positive wire 176 and the negative wire 178) can be substantially circular in cross-section. Such wires can be referred to as substantially round wires. In other aspects, the second wire 170 may not be substantially round.

The first wire 160 can be electrically connected to the circuit board 130; the circuit board 130 can be electrically connected to the second wire 170; and the second wire 170 can be electrically connected to the securing tooth 154. Thus, in an unfastened configuration (shown), the freight security device 100 can form an open circuit.

As previously mentioned, the freight security device 100 can be provided with a tamper detection feature. Once the user has fed the first strap 102 through the slot 152 of the second strap 104 to a desired location, the user can then tug the first strap 102 in reverse (i.e., in the loosening direction). As described above, the ratchet teeth 155 can prohibit the first strap 102 from sliding backward through the slot 152.

In one example aspect, the force provided by tugging the first strap 102 in the loosening direction can cause the securing tooth 154 to pierce through the plastic material (or other material) of the first strap body 112. Additionally, the securing tooth 154 can contact the first wire 160 embedded within the first strap body 112, which can close the circuit of the freight security device 100 and allow an electrical current to flow continuously therethrough in some aspects.

In other example aspects, upon securing the freight security device 100 in the looped configuration, the circuit of the freight security device 100 can close and allow an electrical current to flow continuously therethrough.

In one example method of using the freight security device 100, the freight security device 100 can be wrapped around a pair of adjacent door handles of a freight container, and the insertion end 144 of the first strap 102 can be fed through the slot 152 of the second strap 104. The ratchet teeth 155 can prohibit withdrawal of the first strap 102 from the slot 152, securing the freight security device 100 in the looped configuration. The secure, continuous loop of the freight security device 100 around the handles of the freight container can prohibit the doors from being opened.

In other aspects, the freight security device 100 can be configured to secure the freight container in a closed configuration in any suitable manner. For example and without limitation, in a freight container comprising a singular door, the freight security device 100 may be looped through a handle of the door and through an opening formed through an adjacent portion of the freight container (such as a sidewall, for example). In another aspect, the freight security device 100 can be looped through an opening in the door and through an opening in the transportation vehicle. In another aspect, the freight security device 100 can be looped through a latch of the freight container to prevent a door of the freight container from being unlatched.

The circuit of the freight security device 100 can then be completed (i.e., closed) by feeding the first strap 102 through the slot 152 of the second strap 104 to a desired location. In some example aspects, the circuit of the freight security device 100 can then be completed (i.e., closed) by tugging the first strap 102 in the loosening direction (or by tugging the second strap 104 in the opposite direction), which can pierce the securing tooth 154 through the first strap body 112 and contact the securing tooth 154 with the first wire 160. In some aspects, the circuit board 130 can be activated when the circuit is completed. The circuit can remain closed until the continuous loop of the freight security device 100 is broken, such as by cutting the freight security device 100 off of the freight container. When the path of the circuit is broken, the circuit board 130 can register than the circuit is no longer closed. In example aspects, a customer can monitor the status of the circuit and/or can receive alerts related to the status of the circuit (e.g., closed circuit or open circuit), and therefore can be informed if the freight security device 100 is tampered with and/or removed prior to delivery of the freight container. In some aspects, the circuit board 130 can automatically notify a user of the breaking of the path.

Additionally, or alternatively, the freight security device 100 may be provided with a fall detection feature. Fall detection features can be those understood by one of ordinary skill in the art and available on the market. For example, the fall detection feature may comprise an accelerometer and/or gyroscope configured to detect changes in acceleration and rotation, respectively. For example, when the freight security device 100 is cut from the freight container, the freight security device 100 may fall to the ground, which can be detected by the fall detection feature. As such, in example aspects, the fall detection feature can detect if the freight security device 100 has been tampered with and/or removed prior to delivery of the freight container, and this information can be relayed to the consumer. The accelerometer and/or the gyroscope can be housed within the interior 120 of the housing 106.

Example aspects of the freight security device 100 can also be provided with a location tracking feature. For example, the freight security device 100 can be equipped with the GPS receiver that can allow a customer to track the location of the freight container during transportation. Such GPS receivers can be those understood by one of ordinary skill in the art and available on the market. The GPS receiver can be housed within the interior 120 of the housing 106.

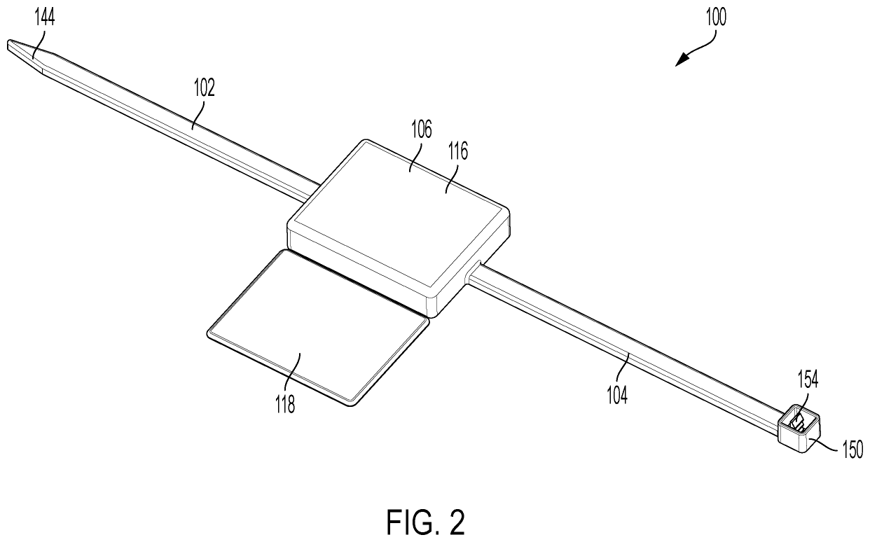

FIG. 2 illustrates a bottom perspective view of the freight security device 100.

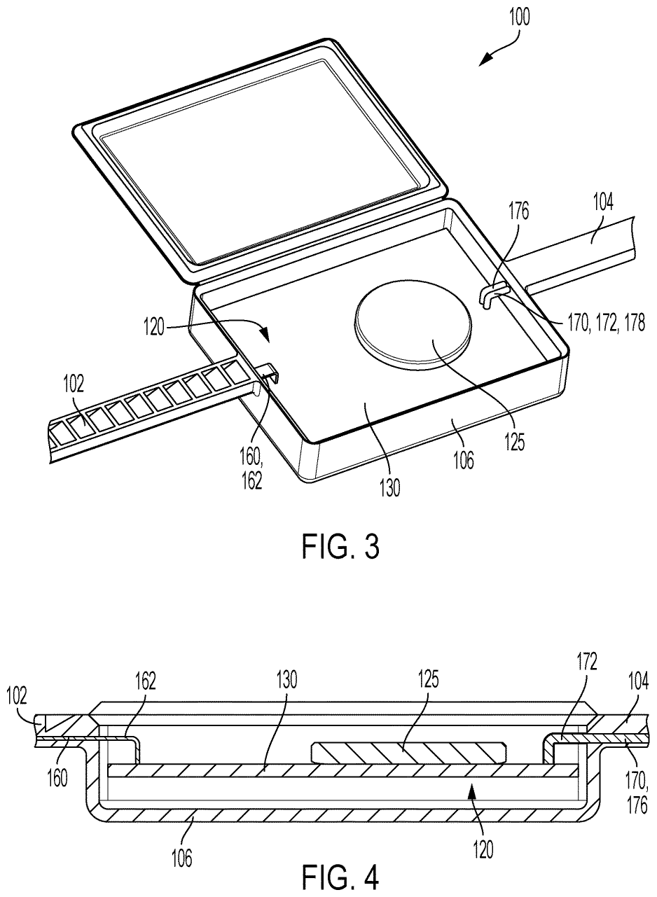

FIG. 3 illustrates a detail view of the housing 106 of the freight security device 100. As shown, the battery 125 can be mounted to the circuit board 130. Both the battery 125 and the circuit board 130 can be housed within the interior 120 of the housing 106. Each of the proximal first wire end 162 of the first wire 160 and the proximal second wire end 172 of the second wire 170 (that is, both the positive wire 176 and the negative wire 178) can extend into the interior 120 of the housing 106 and can be connected to the circuit board 130. FIG. 4 illustrates a cross-sectional view of the housing 106.

FIGS. 5 and 6 illustrate top perspective and cross-sectional views, respectively, of the first strap 102. Referring to FIG. 5, in example aspects, the width of the first strap 102 can taper at the insertion end 144 to define a tapered end portion 512, as shown. The tapered end portion 512 can facilitate inserting the insertion end 144 of the first strap 102 through the slot 152 (shown in FIG. 1) of the second strap 104 (shown in FIG. 1). The cross-sectional view of FIG. 6 shows the canted tooth surface 510 and the perpendicular tooth surface 610 of each of the ratchet teeth 155.

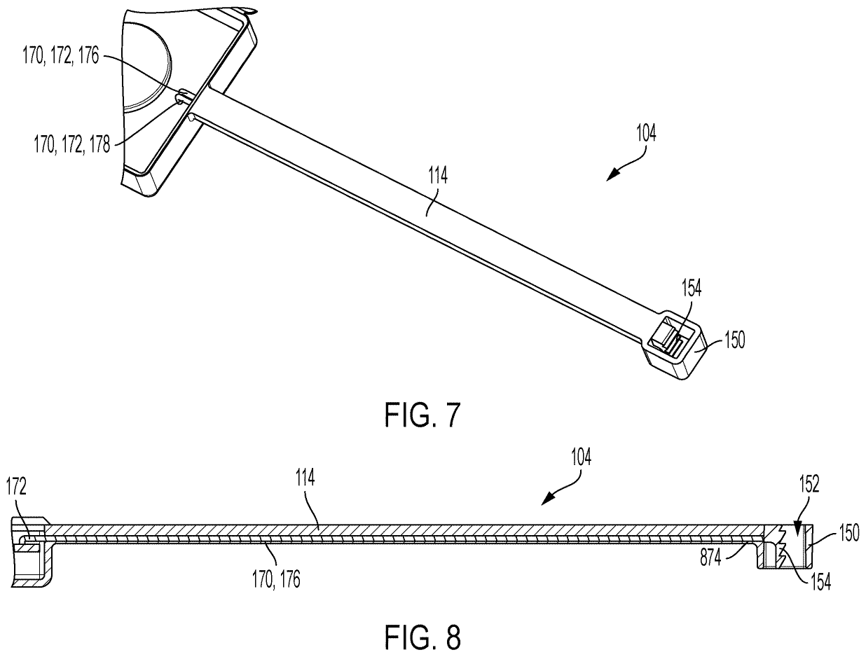

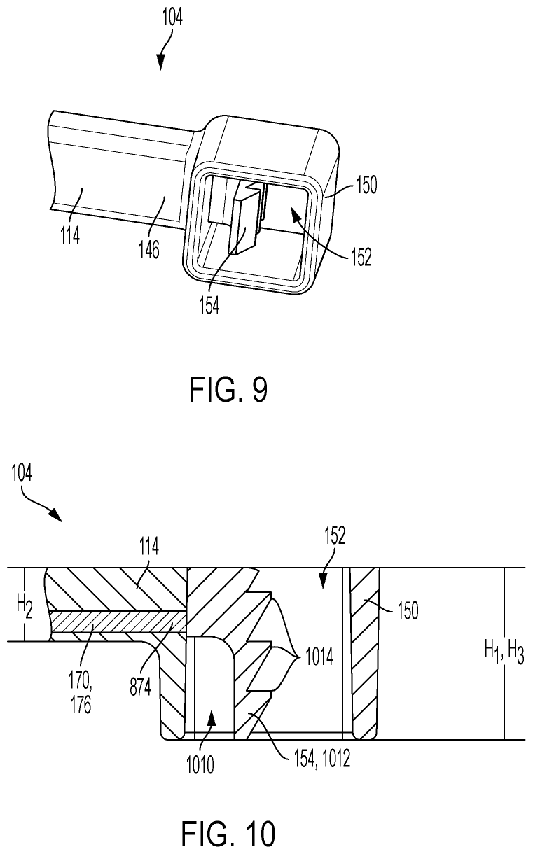

FIGS. 7 and 8 illustrate top perspective and cross-sectional views, respectively, of the second strap 104. FIGS. 9 and 10 illustrate bottom perspective and cross-sectional views, respectively, of the head 150 of the second strap 104. As best seen in FIG. 10, in some aspects, a height H₁ of the head 150 can be greater than a height H₂ of the remainder of the second strap body 114. The increased height H₁ can provide added reinforcement to the head 150. In other aspects, the height H₁ of the head 150 can be greater or lesser than the height H₂ of the remainder of the second strap body 114. In some aspects, a height H₃ of the securing tooth 154 can be about equal to the height H₁ of the head 150. In other aspects, the height H₃ of the securing tooth 154 can be greater or lesser than the height H₁ of the head 150.

With continuing reference to FIG. 10, example aspects of the securing tooth 154 can extend into the slot 152, substantially outward and downward from the head 150, relative to the orientation shown. That is, in the present orientation, the securing tooth 154 can generally define an inverted L-shape. A gap 1010 can be formed between the head 150 and a distal tooth portion 1012 of the securing tooth 154, which can allow to distal tooth portion 1012 to flex as needed as the first strap 102 (shown in FIG. 1) is pulled through the slot 152. In some aspects, the securing tooth 154 can be provided with one or more projections 1014 jutting into the slot 152. In example aspects, the one more projections 1014 can aid in gripping the first strap 102 and can facilitate cutting into the first strap body 112 (shown in FIG. 1) to contact the securing tooth 154 with the first wire 160 (shown in FIG. 1).

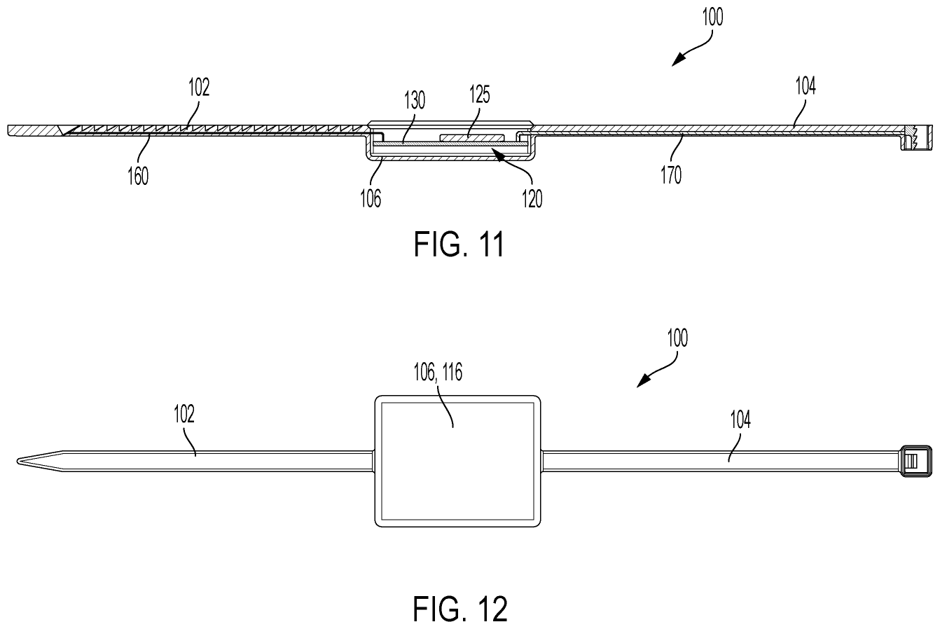

FIG. 11 is a cross-sectional view of the freight security device 100.

FIG. 12 is a bottom view of the freight security device 100, wherein the housing cover 118 (shown in FIG. 1) is folded over the housing opening 122 (shown in FIG. 1) and secured to the housing body 116 to enclose the interior 120 (shown in FIG. 1) of the housing 106 in the closed position.

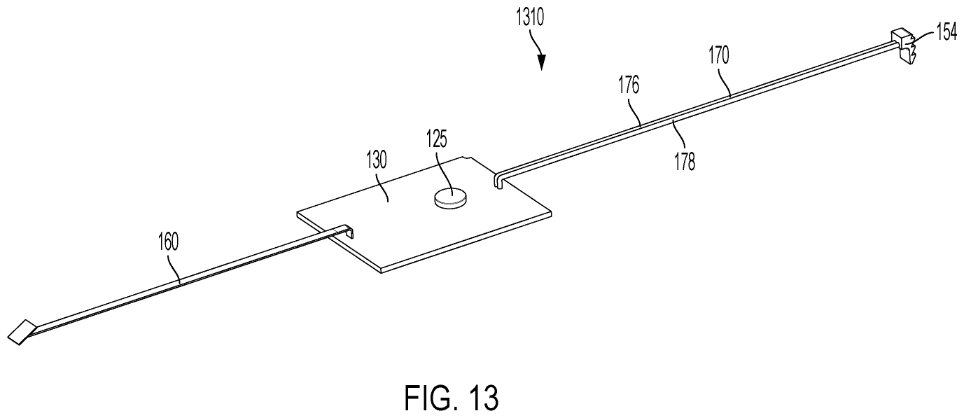

FIG. 13 is a top perspective view of circuit components 1310 of the freight security device 100 (shown in FIG. 1), including the first wire 160, the second wire 170 (including the positive wire 176 and the negative wire 178), the circuit board 130, the battery 125, and the securing tooth 154.

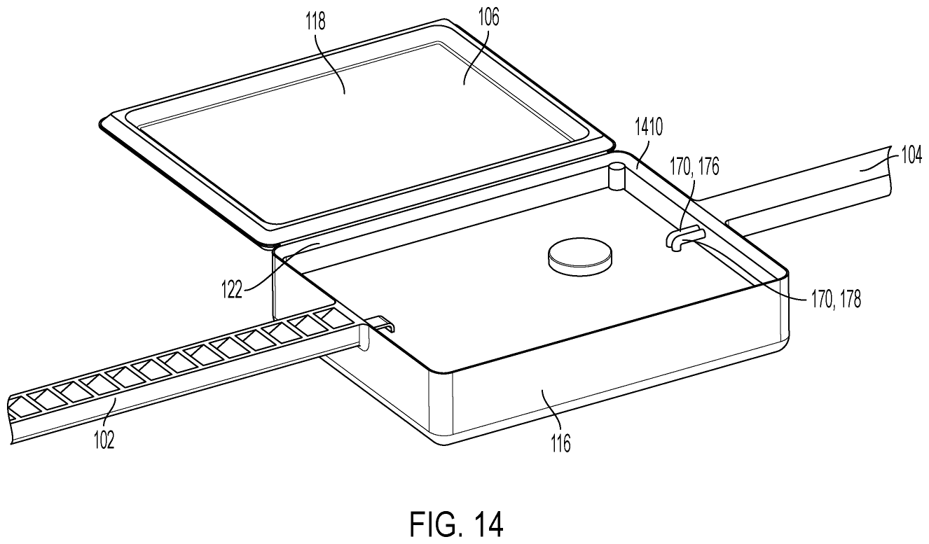

FIG. 14 illustrates a top perspective view of the housing 106 with the housing cover 118 in the open position. The housing body 116 can define an upper edge 1410, which can define the housing opening 122. In example aspects, the upper edge 1410 can be beveled, as shown. For example, the upper edge 1410 can be angled at about 45° in some aspects. In other aspects, the upper edge 1410 can be angled at any other suitable angle. In other aspects, the upper edge 1410 may not be beveled. To seal the housing cover 118 with the housing body 116 in the closed position, the beveled upper edge 1410 can heated with an angled heating tool (such as a heat gun having a 45° angled nozzle) to melt the plastic at the upper edge 1410, and the housing cover 118 can then be folded towards the housing body 116 and pressed against the heated upper edge 1410. When the heated plastic cools and solidifies, the housing cover 118 can be sealed with the housing body 116.

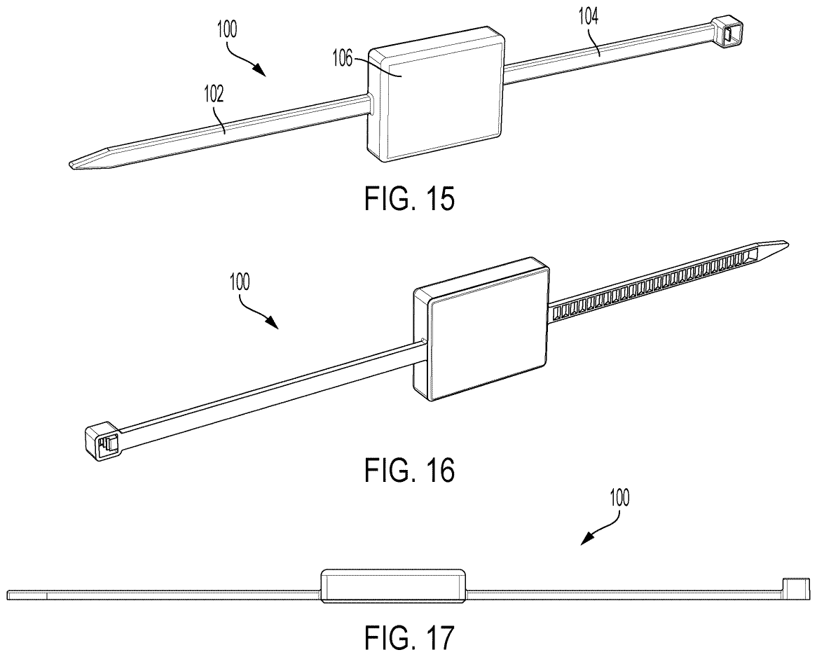

FIGS. 15-17 illustrate top perspective, bottom perspective, and front views, respectively, of the freight security device 100 in accordance with another example aspect of the present disclosure, wherein the housing 106 is sealed in the closed position.

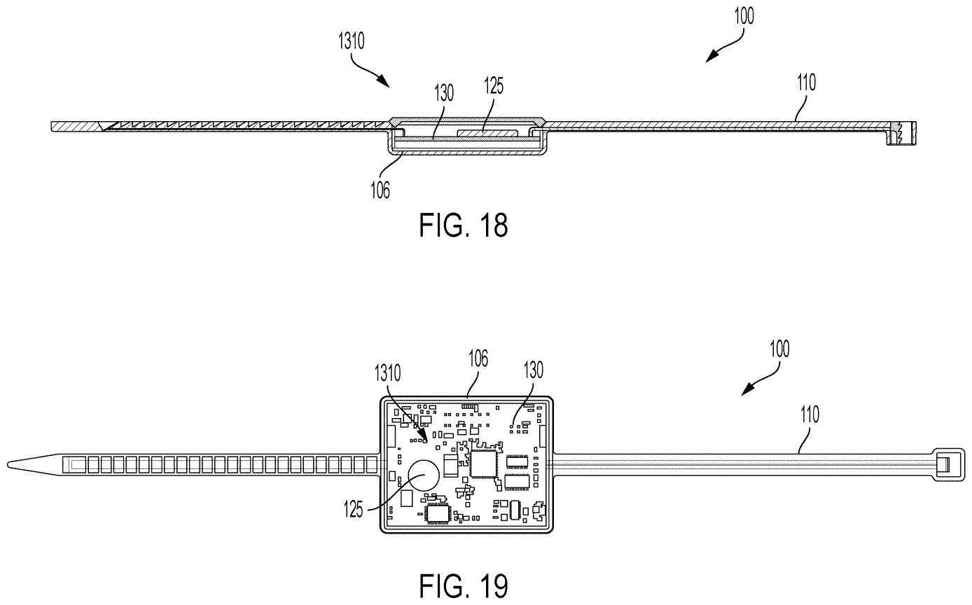

FIGS. 18 and 19 illustrate front and top views, respectively, of the freight security device 100 of FIGS. 15-17. The security device body 110 is illustrated as transparent for visibility of the various circuit components 1310 and internal components of the housing 106. Various components of the location tracking feature and the fall detection feature can be arranged within the interior 120 of the housing 106 and mounted to the circuit board 130. For example, the location tracking feature can comprise the GPS receiver, which can be formed as a GPS receiver chip. Additionally, the fall detection feature can comprise the gyroscope and the accelerometer, which can be integrated into a single fall detection chip in some aspects. In other aspects, the accelerometer and the gyroscope can be integrated into separate fall detection chips. Additionally, in some aspects, microchips can be integrated to provide wireless connectivity, such as cellular, Bluetooth, wi-fi, Thread, Zigbee, DECT NR+, etc. The battery 125 can also be received within the housing 106, as shown.

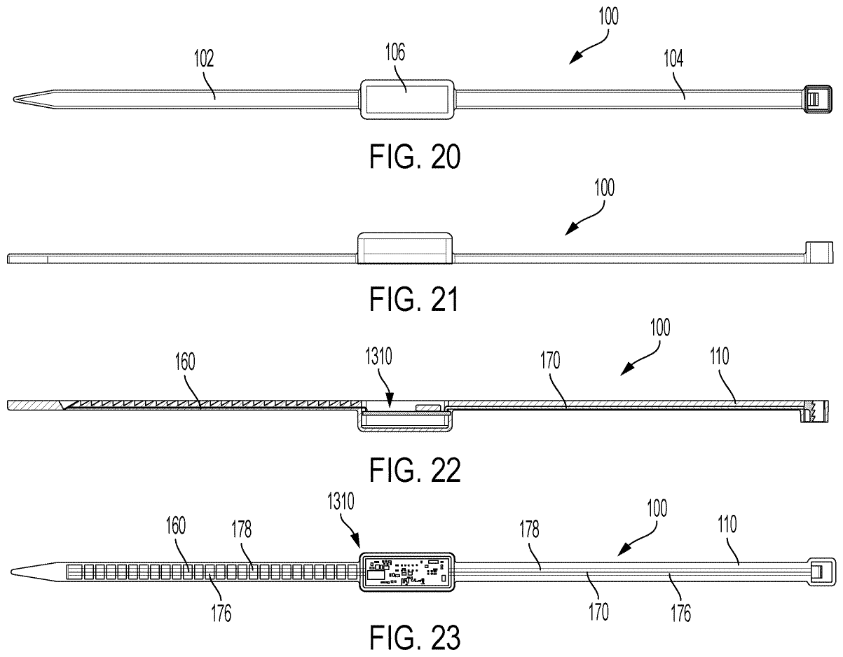

FIGS. 20 and 21 illustrate top and front views, respectively, of another example aspect of the freight security device 100. The aspect of FIGS. 20 and 21 can be similar to the aspects previously described; however, the housing 106 can be smaller in the present aspect. FIGS. 22 and 23 illustrate front and top views, respectively, of the freight security device 100 of FIGS. 20 and 21, wherein the security device body 110 is illustrated as transparent for visibility of the various circuit components 1310 and internal components of the housing 106. Moreover, in the present aspect, each of the first wire 160 and the second wire 170 can comprise one of the positive wires 176 and one of the negative wires 178.

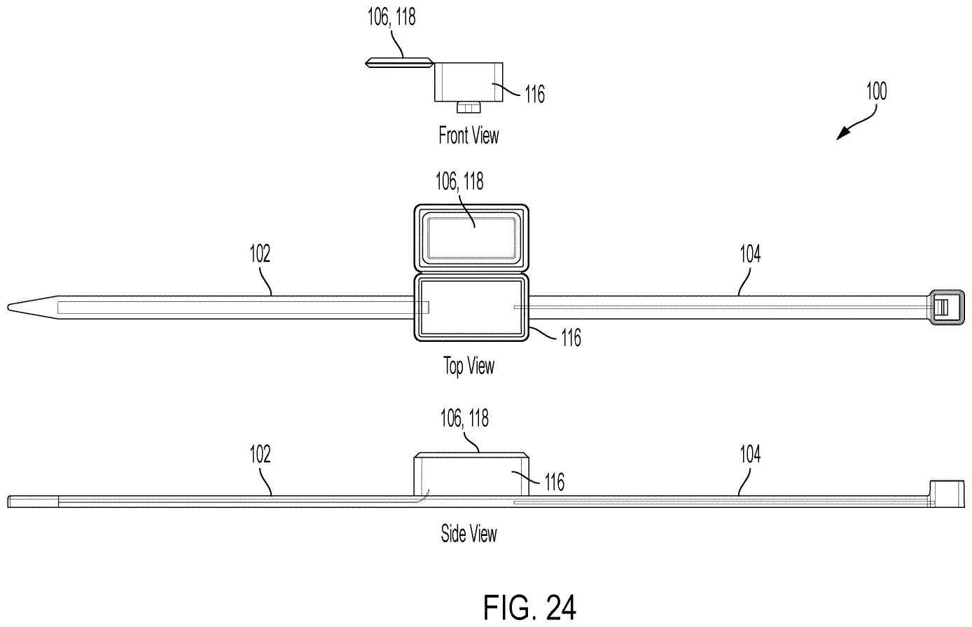

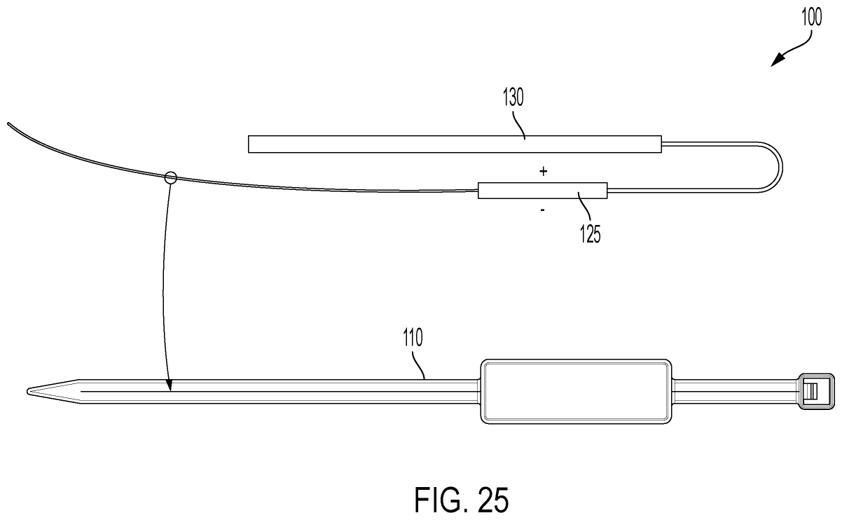

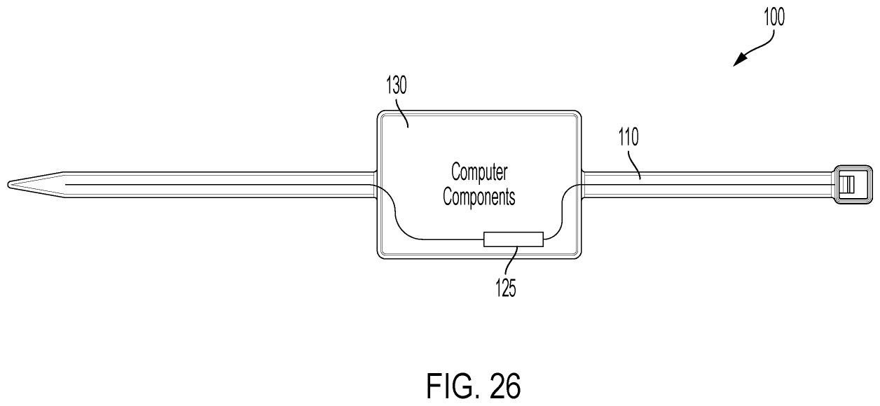

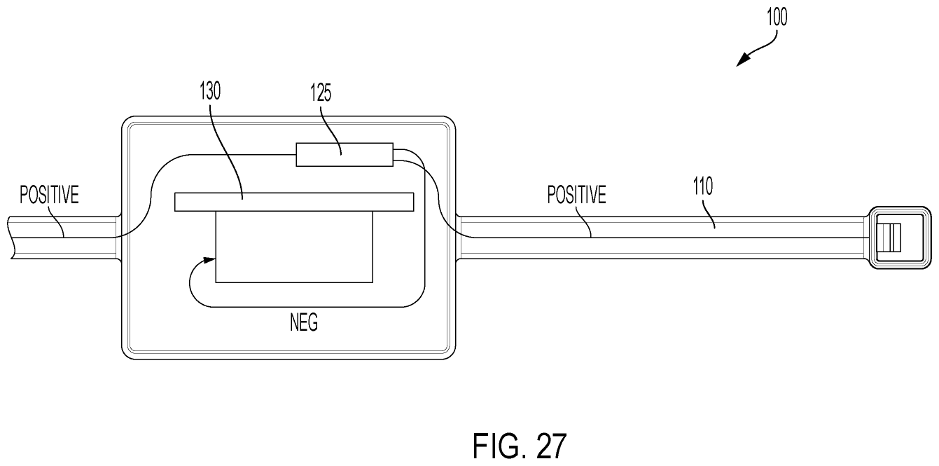

Each of FIGS. 24, 25, 26, and 27 illustrate additional example aspects of the freight security device 100. In the example aspect of FIG. 24, a flat copper wire can extend substantially along the first strap 102 and one or more round copper wires can extend substantially along the second strap 104. In the example aspect of FIG. 25, one wire can connect the circuit board 130 to the battery 125, and another wire can connect to the battery 125 and run substantially along a length of the security device body 110. In the example aspect of FIG. 26, a singular wire can connect to the battery 125 and extend substantially along the length of the security device body 110, and the battery 125 can be directly connected to the circuit board 130. In the example aspect of FIG. 27, a singular positive wire can connect to the battery 125 and extend substantially along the length of the security device body 110, and a negative wire can connect the battery 125 to the circuit board 130.

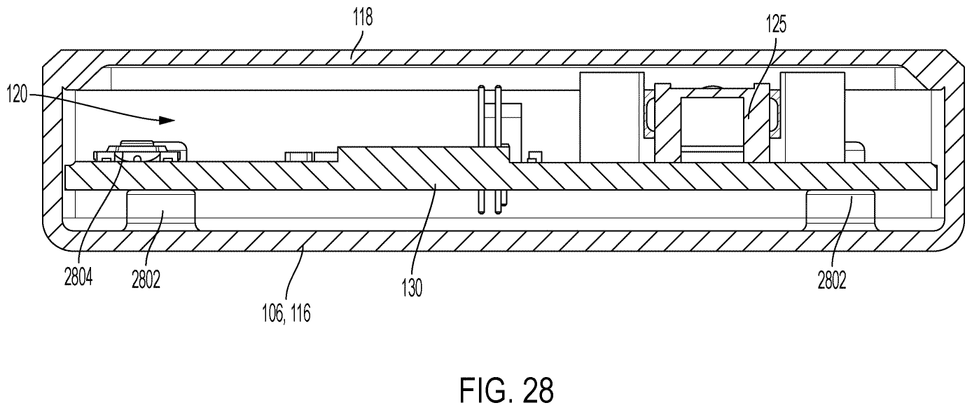

FIG. 28 illustrates additional example aspects of the freight security device 100. In the example aspect of FIG. 28, one or more support members 2802 can be attached to the interior 120 of the housing body 116. In some aspects, the one or more support members 2802 can attach in each corner of the interior 120 of the housing body 116. In some aspects, the one or more support members 2802 can attach to the interior 120 of the housing body 116 to inhibit the movement of the circuit board 130. The circuit board 130 can be placed on top of the one or more support members 2802 inside the housing body 116 in some aspects. In some aspects, after the circuit board 130 is placed on top of the one or more support members 2802 in the housing body 116, the battery 125 of the circuit board 130 can touch the housing cover 118 upon the sealing of the housing cover in the closed position. In some aspects, the one or more support members 2802 can touch the housing cover 118 upon the sealing of the housing cover in the closed position. In other aspects, the one or more support members 2802 may not touch the housing cover 118 upon the sealing of the housing cover in the closed position. In example aspects, the one or more support members 2802 can be made of plastic, electrically conductive plastic, metal material, non-conductive materials, etc. In some example aspects, the one or more support members 2802 can contain a camber on a top edge of the one or more support members 2802. The one or more support members 2802 can be a circular, rectangular, square, oval, or other shapes in some aspects. In some example aspects, the circuit board 130 can comprise cut outs in a shape of the one or more support members 2802. In example aspects, the one or more support members 2802 can be disposed through the cut outs of the circuit board 130. In some aspects, the one or more support members 2802 can comprise a step out, wherein the circuit board 130 is held in place on the one or more support members 2803 by the step out.

In some aspects, the circuit board 130 can contain rounded edges of the circuit board 130. In some aspects, the circuit board 130 can contain one or more notches, wherein the one or more notches correspond where the first wire 160 extends from the circuit board 130 into the first strap 102. In some aspects, the one or more notches of the circuit board 130 can correspond where the second wire 170 extends from the circuit board 130 into the second strap 114. In some aspects, the one or more notches of the circuit board 130 can be cut large enough to allow the bending of the first wire 160 or the second wire 170. The one or more notches of the circuit board 130 can be semi-circular, square, oval, etc.

In example aspects, a light 2804 can be mounted to the circuit board 130 and configured to illuminate or stop illuminating in connection with the closing or the opening of the circuit of the freight security device 100. In example aspects, the light 2804 can be visible through the security device body 110. Additionally, the light 2804 can be mounted to the exterior of the security device body 110 in some aspects.

In example aspects, after the freight security device 100 forms a closed circuit, the freight security device 100 can remove or wipe data contained in the circuit board 130, any of the various circuit components 1310, or the freight security device 100 upon the breaking of the path of the circuit. In some aspects, the freight security device 100 can be reused after the wiping of data. In some aspects, after a closed circuit is broken, the freight security device 100 can be reused and be configured back into a closed configuration in any suitable manner.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A freight security device comprising:
a first strap comprising a first strap body and a first wire embedded within the first strap body;
a second strap comprising a second strap body and a second wire embedded within the second strap body, the second strap further comprising a head, the head comprising a securing tooth; and
a housing disposed between the first strap and the second strap, the housing comprising a circuit board, each of the first wire and the second wire connected to the circuit board;
wherein the first strap is configured to be fed through the head of the second strap and close a circuit of the freight security device.

2. The freight security device of claim 1, wherein the first strap extends from the housing in a first direction and the second strap extends from the housing in a second direction opposite the first direction.

3. The freight security device of claim 2, wherein the second strap body defines a proximal second strap end and a distal second strap end opposite the proximal second strap end, the proximal second strap end is connected to the housing, and the head is arranged at the distal second strap end.

4. The freight security device of claim 3, wherein:
the first strap body defines a proximal first strap end and a distal first strap end opposite the proximal first strap end;
the proximal first strap end is connected to the housing; and
the second strap body defines a plurality of ratchet teeth arranged at least partially along a length of the second strap.

5. The freight security device of claim 4, wherein a width of the first strap body at the distal first strap end thereof is tapered to facilitate feeding the distal first strap end of the first strap body through the head of the second strap.

6. The freight security device of claim 1, further comprising a location tracking feature, the location tracking feature comprising a GPS receiver disposed within the housing and connected to the circuit board.

7. The freight security device of claim 1, further comprising a fall detection feature, the fall detection feature comprising at least one of a gyroscope and an accelerometer, the at least one of the gyroscope and the accelerometer disposed within the housing and connected to the circuit board.

8. The freight security device of claim 7, wherein the fall detection feature comprises both of the accelerometer and the gyroscope.

9. The freight security device of claim 8, wherein the accelerometer and the gyroscope are integrated into a single fall detection chip.

10. The freight security device of claim 1, wherein the circuit board is configured to activate when the circuit is closed.

11. The freight security device of claim 10, wherein the circuit board is configured to detect when a path of the circuit is broken.

12. The freight security device of claim 10, wherein the circuit board is configured to trigger an alert when the path of the circuit is broken.

13. The freight security device of claim 10, further comprising a light, wherein the light is configured to illuminate when the circuit is closed.

14. The freight security device of claim 1, wherein the first strap, the second strap, and the house are made of an electrically conductive plastic material.

15. A freight security device comprising:
a first strap comprising a first strap body and a first wire embedded within the first strap body;
a second strap comprising a second strap body and a second wire embedded within the second strap body, the second strap further comprising a head, the head comprising a securing tooth contacting the second wire; and
a housing disposed between the first strap and the second strap, the housing comprising a circuit board, each of the first wire and the second wire connected to the circuit board;
wherein the first strap is configured to be fed through the head of the second strap, and wherein, the securing tooth is configured to pierce the first strap body to contact the first wire and to close a circuit of the freight security device.

16. The freight security device of claim 15, wherein the first strap extends from the housing in a first direction and the second strap extends from the housing in a second direction opposite the first direction.

17. The freight security device of claim 16, wherein the second strap body defines a proximal second strap end and a distal second strap end opposite the proximal second strap end, the proximal second strap end is connected to the housing, and the head is arranged at the distal second strap end.

18. The freight security device of claim 17, wherein:
the first strap body defines a proximal first strap end and a distal first strap end opposite the proximal first strap end;
the proximal first strap end is connected to the housing; and
the second strap body defines a plurality of ratchet teeth arranged at least partially along a length of the second strap.

19. The freight security device of claim 18, wherein a width of the first strap body at the distal first strap end thereof is tapered to facilitate feeding the distal first strap end of the first strap body through the head of the second strap.

20. The freight security device of claim 15, wherein the circuit board is configured to activate when the circuit is closed; and wherein the circuit board is configured to trigger an alert when the path of the circuit is broken.
